(19) United States
(12) Patent Application Publication
(10) Pub. No.: US 2026/0097785 A1
(43) Pub. Date: Apr. 9, 2026

(54) ACTIVATION OF ARTIFICIAL INTELLIGENCE MODELS PER DRIVING SCENARIO

(71) Applicant: AUTOBRAINS TECHNOLOGIES LTD, Tel Aviv-Yafo (IL)

(72) Inventor: Igal RAICHELGAUZ, Tel Aviv (IL)

(73) Assignee: AUTOBRAINS TECHNOLOGIES LTD, Tel Aviv-Yafo (IL)

(21) Appl. No.: 18/908,831

(22) Filed: Oct. 8, 2024

Related U.S. Application Data
(63) Continuation of application No. 18/908,816, filed on Oct. 8, 2024.

(51) Int. Cl. B60W 60/00; G06N 20/00; H04W 4/38

(52) U.S. Cl. CPC B60W 60/001; G06N 20/00; H04W 4/38

(57) ABSTRACT

A method of activation of artificial intelligence models for driving related scenarios, the method includes obtaining sensor data input relating to an environment of a vehicle; generating, in a driving of the vehicle, a signature based on the sensor data input; matching, in the driving of the vehicle, the signature with a set of concept signatures that are held in a dictionary of concept signatures in association with driving scenarios; determining a driving scenario, based on the matching; and generating instructions, executable by a processing unit of the vehicle, to issue a notification for activation of a selected set of artificial intelligence models, in accordance with the driving scenario, wherein the activation of the selected set of artificial intelligence models providing a decision making for the driving scenario with an autonomous driving application associated with the vehicle

### BACKGROUND

Vehicles include machine learning processes that are trained to cope with a vast number of scenarios. Nevertheless, following the learning process, the vehicles may face post-training scenarios.

There is a growing need to cope with the post-training scenarios.

### SUMMARY

There is provided a method, a non-transitory computer readable medium and a system as illustrated in the application.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a computerized system;

FIG. 2 illustrates an example of a vehicle;

FIG. 3 illustrates an example of a skill factory in communication with vehicles;

FIG. 4 illustrates examples of inference;

FIG. 5 illustrates an example of a method;

FIG. 6 illustrates an example of a step of the method of FIG. 5;

FIG. 7 illustrates examples of a method;

FIG. 8 illustrates an example of a step of the method of FIG. 7; and

FIG. 9 illustrates an example of a step of the method of FIG. 7.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

The term obtaining include receiving and/or generating.

According to an embodiment a scenario includes at least one of (a) a location of the vehicle, (b) one or more weather conditions, (c) one or more contextual parameters, (d) a road condition, (e) a traffic parameter. Various examples of a road condition may include the roughness of the road, the maintenance level of the road, presence of potholes or other related road obstacles, whether the road is slippery, covered with snow or other particles. Various examples of a traffic parameter and the one or more contextual parameters may include time (hour, day, period or year, certain hours at certain days, and the like), a traffic load, a distribution of vehicles on the road, the behavior of one or more vehicles (aggressive, calm, predictable, unpredictable, and the like), the presence of pedestrians near the road, the presence of pedestrians near the vehicle, the presence of pedestrians away from the vehicle, the behavior of the pedestrians (aggressive, calm, predictable, unpredictable, and the like), risk associated with driving within a vicinity of the vehicle, complexity associated with driving within of the vehicle, the presence (near the vehicle) of at least one out of a kindergarten, a school, a gathering of people, and the like. A contextual parameter may be related to the context of the sensed information—context may be depending on or relating to the circumstances that form the setting for an event, statement, or idea.

According to an embodiment, there is provided a solution that dynamically learns to cope with scenarios—including newly detected scenarios.

According to an embodiment, artificial intelligence models implement skills that are dynamically learnt.

According to an embodiment, artificial intelligence models of a certain point in time may be changes, have one or more artificial intelligence model added and/or or many have one or more artificial intelligence model removed, in order to adapt to newly received driving related data.

Dynamically adding new skills is much simpler and much more effective than generating a vast machine learning process that has to manage all known scenarios.

The current solution includes performing gradual and/or incremental software updates to vehicle that are relatively compact and/or easy to test and/or are more robust than using a single vast machine learning process.

According to an embodiment, a computerized system (such as a skills factory) is used to generate the artificial intelligence models and/or modify the artificial intelligence models and/or dynamically add new artificial intelligence models—and related rules and/or metadata—such as perception router selection rules.

According to an embodiment, the computerized system is in communication with vehicles that selectively apply during inference one or more of the artificial intelligence models.

According to an embodiment, the vehicles are configured to trigger an update and/or generation of a new artificial intelligence model and/or to provide information regarding a scenario (also referred to an edge case) that requires a modification of an existing artificial intelligence model or a generation of a new artificial intelligence model.

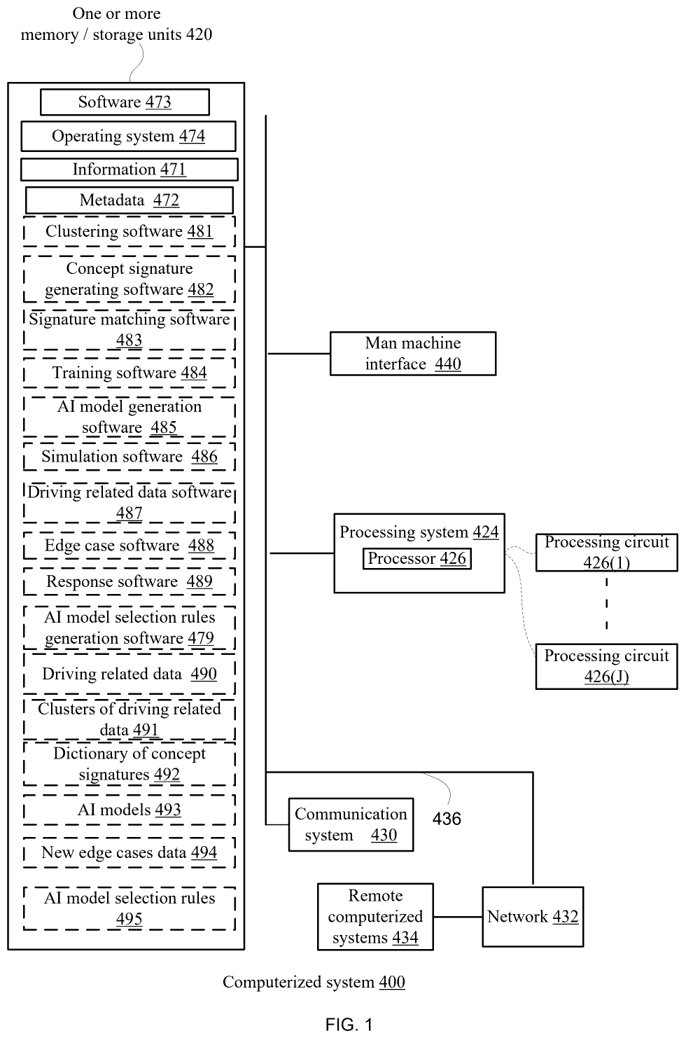

FIG. 1 illustrates an example of a computerized system 400.

Computerized system 400 includes a man machine interface 440 having or being in communication with man machine interface (MMI) controller (not shown), a communication system 430, one or more memory and/or storage units 420, a processing system 424 including processor 426. The computerized system may be a server, a laptop, a desktop or any other computer and may include or be in communication with a sensing unit and/or a controller.

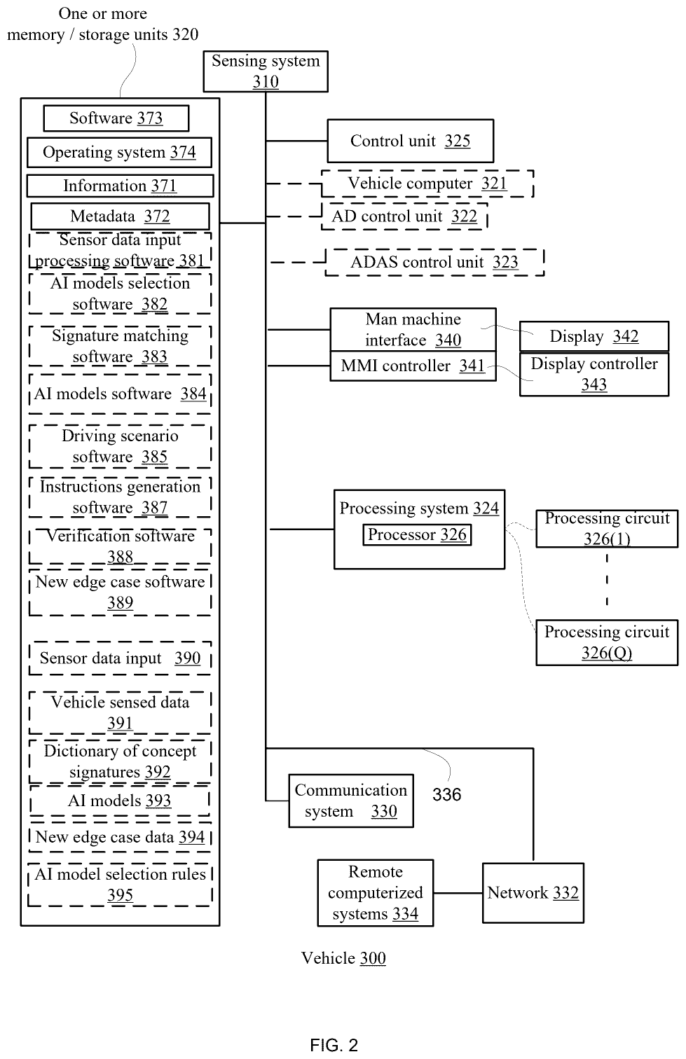

According to an embodiment, computerized system 400 is in communication with network 432 and one or more other remote computerized systems 434 that are in communication with network 432. An example of a remote computerized system is a vehicle (such as vehicle 300 of FIG. 2), a server or one or more computers having access to a storage system.

According to an embodiment, the communication system 430 is configured to enable communication between the one or more memory and/or storage units 420 and/or any one of the additional units and/or the network 432 (that is in communication with the remote computerized systems). Communication system 430 is also configured to enable communication with other elements such as man machine interface 440.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example—any reference to processor should be applied mutatis mutandis to multiple processors, any reference to communication system 430 should be applied mutatis mutandis to multiple communication systems.

According to an embodiment, the one or more memory and/or storage units 420 includes one or more memory unit, each memory unit may include one or more memory banks.

According to an embodiment, the one or more memory and/or storage units 420 includes a volatile memory and/or a non-volatile memory. The one or more memory and/or storage units 420 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

The memory and/or storage units 420 are configured to store firmware and/or software, one or more operating systems, data and metadata required to the execution of any of the methods mentioned in this application.

The memory and/or storage units 420 was shown as storing software. Any reference to software should be applied mutatis mutandis to code and/or firmware and/or instructions and/or commands, and the like.

Various units and/or components are in communication with each other using any communication elements and/or protocols. An example of a communication system is denoted 430. Other communication elements may be provided.

The communication system 430 may be in communication with bus 436. The bus represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 432 that is located outside the computerized system and is used for communication between the computerized system and at least one remote computing system and/or one or more vehicles. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 430) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 420 may be stored outside the computerized system. It should also be noted that the processor may evaluate signatures generated by a plurality of detectors.

Examples of generating signatures and/or cropping images are provided in U.S. patent application Ser. No. 18/527,701 which is incorporated herein by reference.

According to an embodiment, the memory and/or storage units 420 stores at least one of: operating system 474, information 471, metadata 472, and software 473.

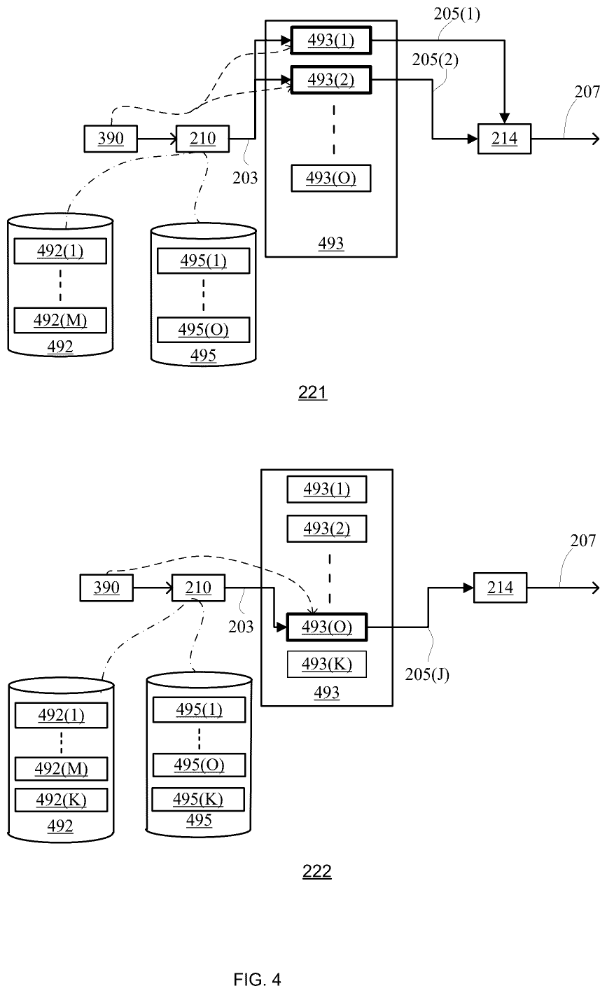

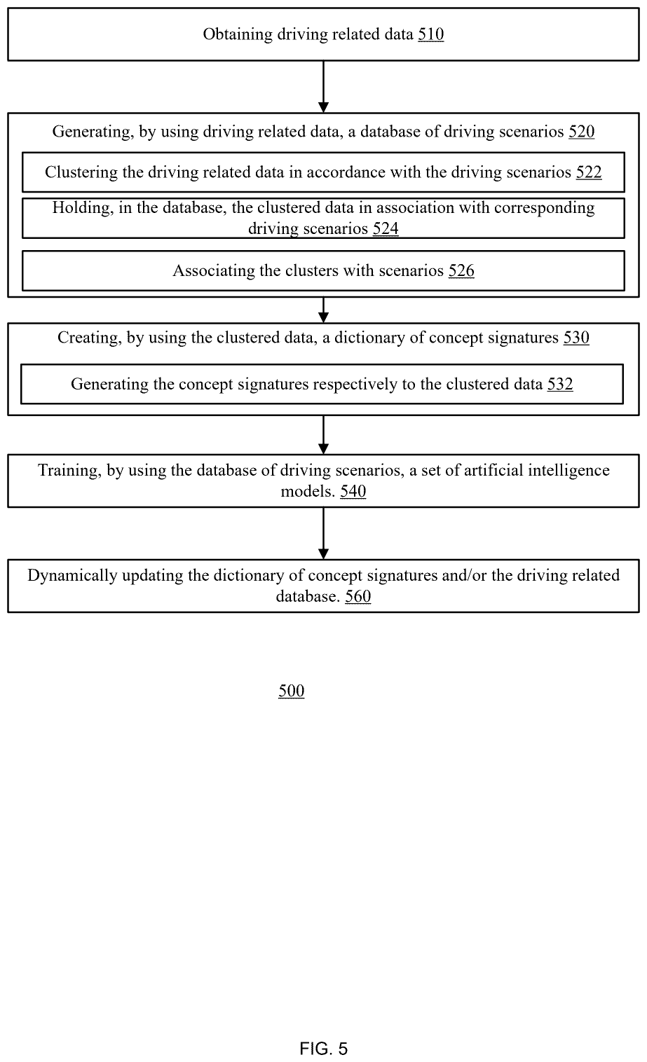

Examples of software include at least one of clustering software 481 (for clustering driving related data and/or clustering concept signature—see for example step 522 and 524 of FIG. 5), concept signature generating software 482 (for generating concept signatures—for example during step 530 of FIG. 5), signature matching software 483 (for matching driving related data signatures to concept signatures), training software 484 (for training—for example during step 540 of FIG. 4), artificial intelligence (AI) model generation software 485 (for generating AI models—for example by training—for example during step 540 of FIG. 4), simulation software 486 (for generating by simulation driving related data—for example during step 510 of FIG. 4), driving related data software 487 (for obtaining driving related data—for example during step 510 of FIG. 4), edge case software 488 (for managing and/or detecting edge case information), response software 489 (for responding to the existence of the edge case information), AI model selection rules generation software 479 (for generating AT model selection rules). Only one or some of these software may be stored in the one or more memory/storage units 420.

Examples of information and/or metadata include at least one of driving related data 490, clusters of driving related data 491, dictionary of concept signatures 492, AI models 493, new edge case data 494, and AI model selection rules 495. Only one or some of these information and/or metadata may be stored in the one or more memory/storage units 420.

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of memory and/or storage units.

According to an embodiment, at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 430. Other communication elements may be provided.

According to an embodiment, processing system 424 is configured to perform method 600 while executing software.

According to an embodiment, processing system 424 is configured to perform at least one of the following when executing software:
Obtain driving related data.
Generate, by using driving related data, a database of driving scenarios.
Create, by using the clustered data, a dictionary of concept signatures.
Train, by using the database of driving scenarios, a set of artificial intelligence models.
Update the dictionary of concept signatures and/or the driving related database. The update may occur multiple times and may be referred to as dynamically update. According to an embodiment the update is done off-line and may not be executed in real time during driving.

According to an embodiment, step 510 includes step 512 of clustering the driving related data in accordance with the driving scenarios and step 514 of holding, in the database, the clustered data in association with corresponding driving scenarios.

According to an embodiment, step 512 includes:
Generating driving related data signatures (also referred to as signatures of the driving related data). The signatures may be embeddings, signatures of embeddings, sparse binary signatures, sparse signatures, or differ from embeddings. Examples of generating signatures and/or cropping images are provided in U.S. patent application Ser. No. 18/527,701 which is incorporated herein by reference.
Clustering the driving related data signatures.
Clustering the driving related data based on the signatures of the driving related data. Accordingly—driving related data units that have signatures that belong to the same signature cluster are clustered together.
Update the dictionary of concept signatures and/or the driving related database.

FIG. 2 illustrates an example of vehicle 300.

Vehicle 300 includes a man machine interface 340 having or being in communication with man machine interface (MMI) controller 341, wherein in FIG. 1 the MMI is a display 342 or includes a display 342 and the MMI controller is a display controller 343 or includes the display controller 343, a communication system 330, one or more memory and/or storage units 320, a processing system 324 including processor 326. The communication system 330, the one or more memory and/or storage units 320, and the processing system 324 may belong to a computerized system of vehicle 300. The computerized system may be a server, a laptop, a desktop or any other computer and may include or be in communication with a sensing unit and/or a controller.

According to an embodiment, vehicle 300 is in communication with network 332 and one or more other remote computerized systems 334 that are in communication with network 332. An example of a remote computerized system is a server or one or more computers having access to a storage system that stores items related to one or more portions of one or more groups of neural networks—at least some of which are not currently stored in the vehicle.

According to an embodiment, the communication system 330 is configured to enable communication between the one or more memory and/or storage units 320 and/or any one of the additional units and/or the network 332 (that is in communication with the remote computerized systems). Communication system 330 is also configured to enable communication with other elements such as sensing system 310, man machine interface 340, control unit 325, vehicle computer 321, autonomous driving control unit 322 (denoted AD control unit), advanced driver assistance system (ADAS) control unit 323 (denoted ADAS control unit), and the like.

The memory and/or storage units 320 was shown as storing software. Any reference to software should be applied mutatis mutandis to code and/or firmware and/or instructions and/or commands, and the like.

Processor 326 includes a plurality of processing units 326(1)-326(Q), Q is an integer that exceeds one. Any reference to one unit or item should be applied mutatis mutandis to multiple units or items. For example—any reference to processor should be applied mutatis mutandis to multiple processors, any reference to communication system 330 should be applied mutatis mutandis to multiple communication systems.

According to an embodiment, the one or more memory and/or storage units 320 includes one or more memory unit, each memory unit may include one or more memory banks.

Any reference to memory and/or storage units 420 should be applied mutatis mutandis to one or more memory and/or storage units 320.

Any reference to communication system 430 should be applied mutatis mutandis to communication system 330.

Any reference to bus 436 should be applied mutatis mutandis to bus 336.

Any reference to network 432 should be applied mutatis mutandis to network 332.

According to an embodiment, the memory and/or storage units 320 stores at least one of: operating system 374, information 371, metadata 372, and software 373.

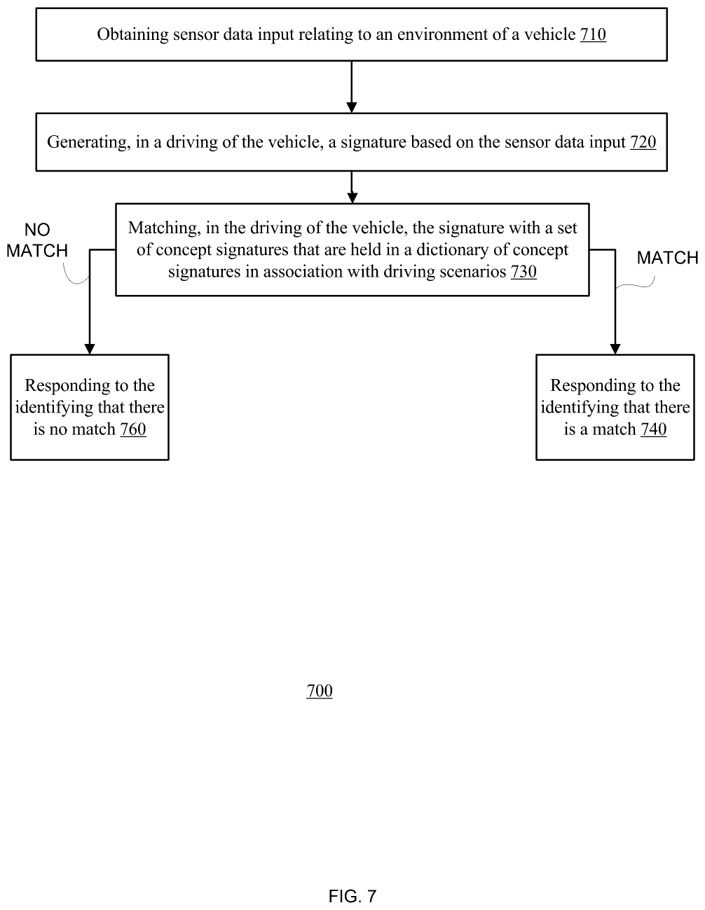

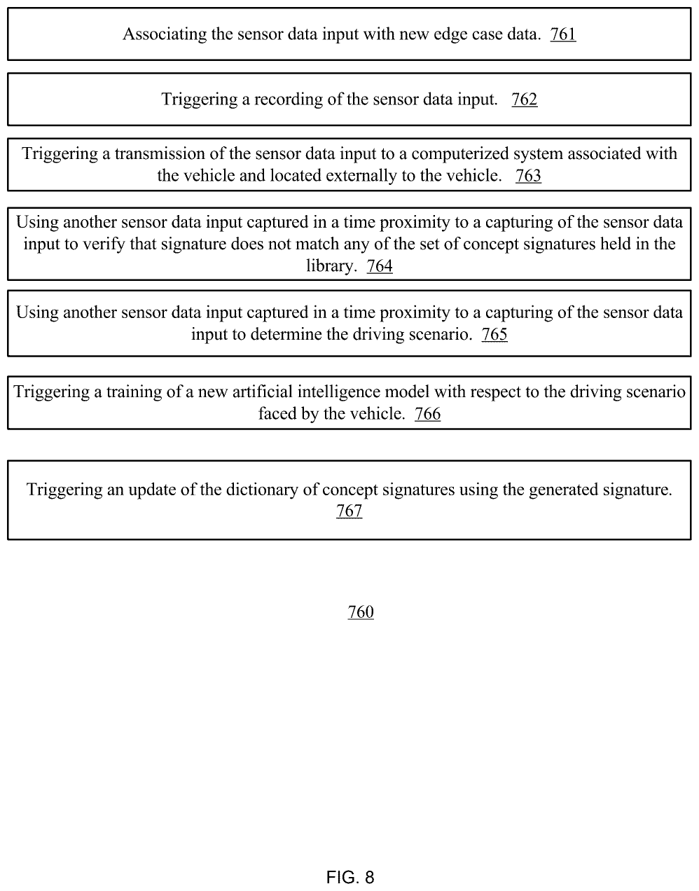

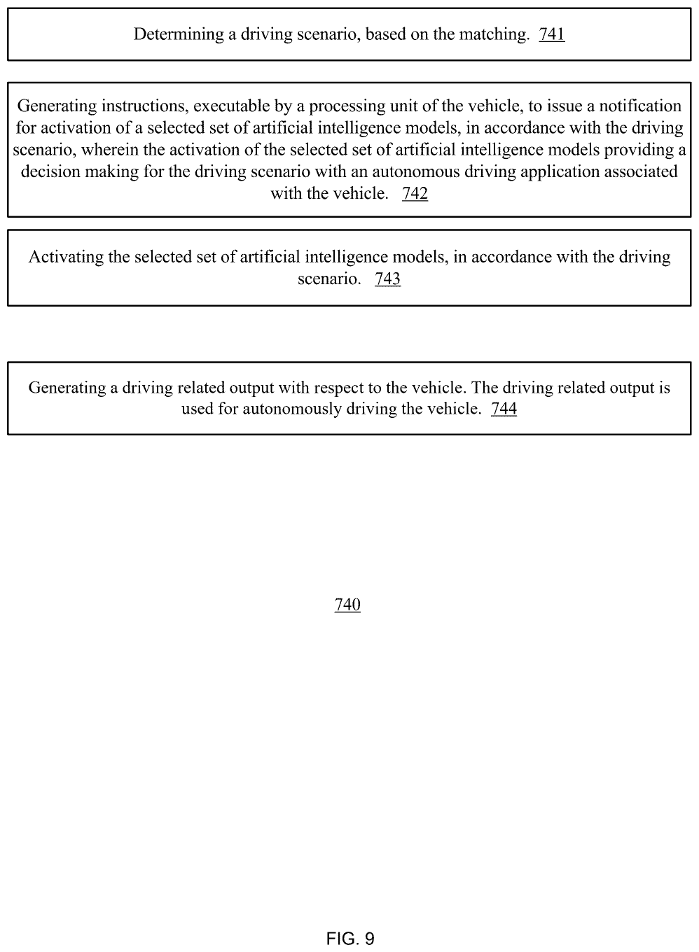

Examples of software include at least one of sensor data input processing software 381 (for obtaining sensor data input during inference—see for example step 710 of FIG. 7), AI model selection software 382 (for selecting one or more AI models during inference), signature matching software 383 (for matching sensor data input signatures to concept signatures—for example during step 730 of FIG. 7), AI models software 384 (for implementing the AI models during inference—for example during step 740 of FIG. 7), driving scenario software 385 (for detecting a scenario during inference—for example during step 741 of FIG. 9), instructions generation software 387 (for generating instructions during inference—for example during step 742 of FIG. 9), verification software 388 (for verifying a signature mismatch—for example during step 764 or 765 of FIG. 8), new edge case software 389 (for detecting a new edge case and/or for managing a new edge case—for example during step 760 of FIG. 7). Only one or some of these software may be stored in the one or more memory/storage units 320.

Examples of information and/or metadata include at least one of sensor data input 390, vehicle sensed data 391 regarding the status of the vehicle, dictionary of concept signatures 392, AI models 393, new edge case data 394, and AI model selection rules 395. Only one or some of these information and/or metadata may be stored in the one or more memory/storage units 320.

The control unit 325 may cooperate with ADAS control unit 323 and/or with AD control unit 322 and/or may control or communicate with other vehicle components—including vehicle computer.

The ADAS control unit 323 is configured to control ADAS operations.

The AD control unit 322 is configured to control autonomous driving of the autonomous vehicle.

The vehicle computer 321 is configured to control the operation of the vehicle—especially controlling the engine, the transmission, and any other vehicle system or component.

The vehicle computer 321 may be in communication with an engine control module, a transmission control module, a powertrain control module, and the like.

The sensing system 310 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 310 is configured to output one or more sensed information units (SIUs).

Control unit 325 is configured to control the operation of the sensing system 310, and/or the one or more memory and/or storage units 320 and/or the one or more additional units (except the controller).

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of memory and/or storage units.

According to an embodiment, at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 330. Other communication elements may be provided.

According to an embodiment, processing system 324 is configured to perform method 600, while executing software.

According to an embodiment, processing system 324 is configured to perform, while executing software:
Obtain sensor data input relating to an environment of a vehicle.
Generate, in a driving of the vehicle, a signature based on the sensor data input.
Match, in the driving of the vehicle, the signature with a set of concept signatures that are held in a dictionary of concept signatures in association with driving scenarios.
Respond to the identifying that there is no match
Respond to the identifying that there is a match.

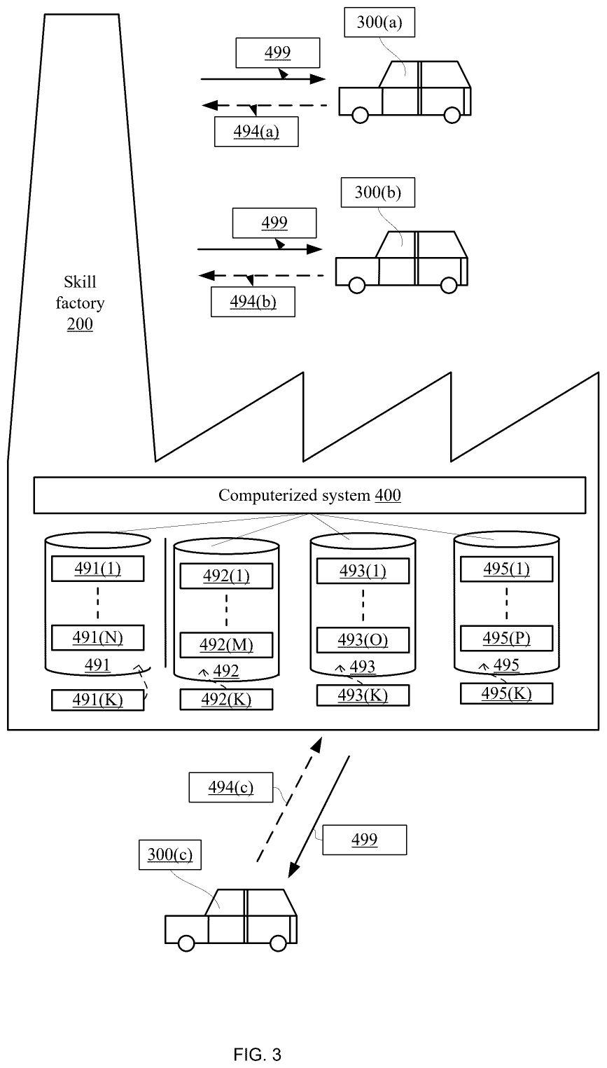

FIG. 3 illustrates an example of a skill factory 200 in communication with three vehicles 300(1), 300(b) and 300(c).

Skill factory 200 includes computerized system 400 of FIG. 1.

Computerized system 400 includes one or more memory and/or storage units that store driving related data 491, dictionary of concept signatures 492, AI models 493, and AI model selection rules 495.

At a certain point in time, driving related data 491 included N driving related data unit clusters 491(1)-491(N), dictionary of concept signatures 492 included M concept signatures 491(1)-491(M), AI models 493 includes O AI models 493(1)-493(O), and AI model selection rules 495 included P AI model selection rules 495(1)-495(P).

FIG. 3 illustrates that a dynamic update was triggered by the reception of one or more new edge case data units 494(a), 494(b) and 494(v) from vehicles 300(1), 300(b) and 300(c). The dynamic update included adding one or more driving related data unit clusters (such as driving related data unit cluster 491(K)), adding one or more concept signatures (such as concept signature 492(K)), adding one or more AI models (such as AI model 493), and adding one or more AI models election rules (such as models election rule 495(K).

These updates will allow the vehicles to accurately manage a new edge case.

These updates are sent to the vehicles during software updates denoted 499.

FIG. 4 illustrates a first example 221 that occurred before the update shown in FIG. 3 and a second example that occurred after the update shown in FIG. 3.

In the first example 221, the driving related data 491 included N driving related data unit clusters 491(1)-491(N), dictionary of concept signatures 492 included M concept signatures 491(1)-491(M), AI models 493 includes O AI models 493(1)-493(O), and AI model selection rules 495 included P AI model selection rules 495(1)-495(P).

In the first example, a perception router 210 receives a sensor data input 390 that represents a first scenario that requires to select first and second AI models 493(1) and 493(2) respectively, to provide first decision 205(1) and second decision 205(1) from the first and second AI models 493(1) and 493(2). The first and second decisions are provided to a decision unit 214 that provides a driving related output 207.

The perception router 210 bases its decision on a matching to one or more concept signatures of the dictionary of concept signatures 492, and on the AI model selection rules 495 that map the matched signature (scenario associated with the matched signature) to the AI models.

In the second example 221, the driving related data 491 included N+1 driving related data unit clusters 491(1)-491(N) and 491(K), the dictionary of concept signatures 492 included M+1 concept signatures 491(1)-491(M) and 491(K), and the AI models 493 includes O+1 AI models 493(1)-493(O) and 493(K), and AI model selection rules 495 included P+1 AI model selection rules 495(1)-495(P) and 495(K).

In the second example, a perception router 210 receives a sensor data input 390 that represents a second scenario that requires to select the O'th AI model 493(O), to provide O'th decision 205(O) from the O'th AI model 493(O). The O'th decision is provided to a decision unit 214 that provides a driving related output 207.

The perception router 210 bases its decision on a matching to one or more concept signatures of the dictionary of concept signatures 492, and on the AI model selection rules 495 that map the matched signature (scenario associated with the matched signature) to the AI models.

FIG. 5 illustrates an example of method 500 for generating artificial intelligence models for driving related scenarios.

According to an embodiment, method 500 starts by step 510 of obtaining driving related data.

According to an embodiment, the driving related data may be sensed by one or more sensors related to one or more vehicles. A sensor related to a vehicle may belong to the vehicle, may be attached to the vehicle, may be spaced apart from the vehicle, may follow a movement of the vehicle, may not follow the movement of the vehicle, may be an aerial sensor, a satellite sensor, an airborne sensor, a ground sensor, and the like.

According to an embodiment, any sensor of the one or more sensors related to the one or more vehicles may be at least one of an image sensor, a non-image sensor, a visible light sensor, a sensor operating in one or more frequencies other than visible light, a radar, a sonar, a magnetometer, a LIDAR, an ultrasonic sensor, an infrared sensor, a near infrared sensor, a radiometer, a thermal sensor, a microwave sensor, a x-ray sensor, a gravitometer, an altimeter, a barometer, a synthetic-aperture radar, a monochromatic sensor, a passive sensor, an active sensor, a sensor for sensing an environment of the vehicle.

According to an embodiment, any sensor of the one or more sensors related to the one or more vehicles may be a vehicle sensor sensing a status of one or more vehicle component (engine, brakes, chassis, wheels, gear, driving wheel, clutch, shock absorber), a vehicle velocity sensor, a vehicle acceleration sensor, and the like.

According to an embodiment, step 510 is followed by step 520 of generating, by using driving related data, a database of driving scenarios.

According to an embodiment, the database of driving scenarios includes information related to an environment and information related to the status of vehicle.

According to an embodiment, the database of driving scenarios includes information related to an environment but does not include information related to the status of vehicle.

According to an embodiment, step 520 includes step 522 of clustering the driving related data in accordance with the driving scenarios and step 524 of holding, in the database, the clustered data in association with corresponding driving scenarios.

According to an embodiment, step 522 includes:
Generating driving related data signatures (also referred to as signatures of the driving related data). The signatures may be embeddings, signatures of embeddings, sparse binary signatures, sparse signatures, or differ from embeddings. Examples of generating signatures and/or cropping images are provided in U.S. patent application Ser. No. 18/527,701 which is incorporated herein by reference.
Clustering the driving related data signatures.
Clustering the driving related data based on the signatures of the driving related data. Accordingly—driving related data units that have signatures that belong to the same signature cluster are clustered together.

According to an embodiment, step 520 includes step 526 of associating the clusters with scenarios. According to an embodiment the association between clusters and scenarios follows the execution of step 520.

According to an embodiment, the driving related data signatures are generated based on the information related to the environment but not on the information related to the status of vehicle.

According to an embodiment, the driving related data signatures are generated based on the information related to the environment and on the information related to the status of vehicle.

According to an embodiment, step 520 is followed by step 530 of creating, by using the clustered data, a dictionary of concept signatures.

According to an embodiment, step 530 includes step 532 of generating the concept signatures respectively to the clustered data-by generating, for each cluster, one or more concept signatures that represent the cluster. This generation of the concept signatures reduces the resources allocated to a matching process—as the matching process is made in relation to the concept signatures—and not in relation each signatures of the clusters.

According to an embodiment, step 530 is executed in association with the corresponding driving scenarios—as each cluster (and accordingly each concept signature) is associated with a scenario.

According to an embodiment, step 530 is followed by step 540 of training, by using the database of driving scenarios, a set of artificial intelligence models.

According to an embodiment, the training of each artificial intelligence model is based on the clustered data stored in the database in accordance with a specified driving scenario, to provide a decision making with respect to the specified driving scenario.

According to an embodiment, step 540 takes into account the information about the vehicle-in order to mimic the behavior of one or more vehicles when facing a certain scenario or at least to be influenced by the behavior of one or more vehicles when facing a certain scenario.

According to an embodiment, the driving scenarios in the database are each associated with a corresponding set of (one or more) concept signatures and with a corresponding set of (one or more) artificial intelligent models.

According to an embodiment, the concept signatures are used at a driving of a vehicle for determining a driving scenario. Accordingly—during inference the concept signatures are used by a perception router when the perception router selects the set of artificial intelligence models to be used when facing a scenario.

According to an embodiment, step 520 of generating the database of driving scenarios is performed autonomously from and independently from step 530 of creating the dictionary of concept signatures.

According to an embodiment, step 520 of generating the database of driving scenarios is performed autonomously from but in dependency from step 530 of creating the dictionary of concept signatures.

According to an embodiment, method 500 includes step 560 of updating the dictionary of concept signatures and/or the driving related database.

According to an embodiment, step 560 is triggered when a new edge case is detected, when it is determined that one or more artificial intelligence models and/or the perception router do not perform in a defined manner (for example are associated with a decision or operation having a below threshold confidence level), and the like.

According to an embodiment, step 560 include repeating and/or fine tuning and/or only partially re-executing any one of steps 520, 530 and 540. This may involve updating and/or replacing and/or removing any part of the dictionary and/or of the driving scenario database.

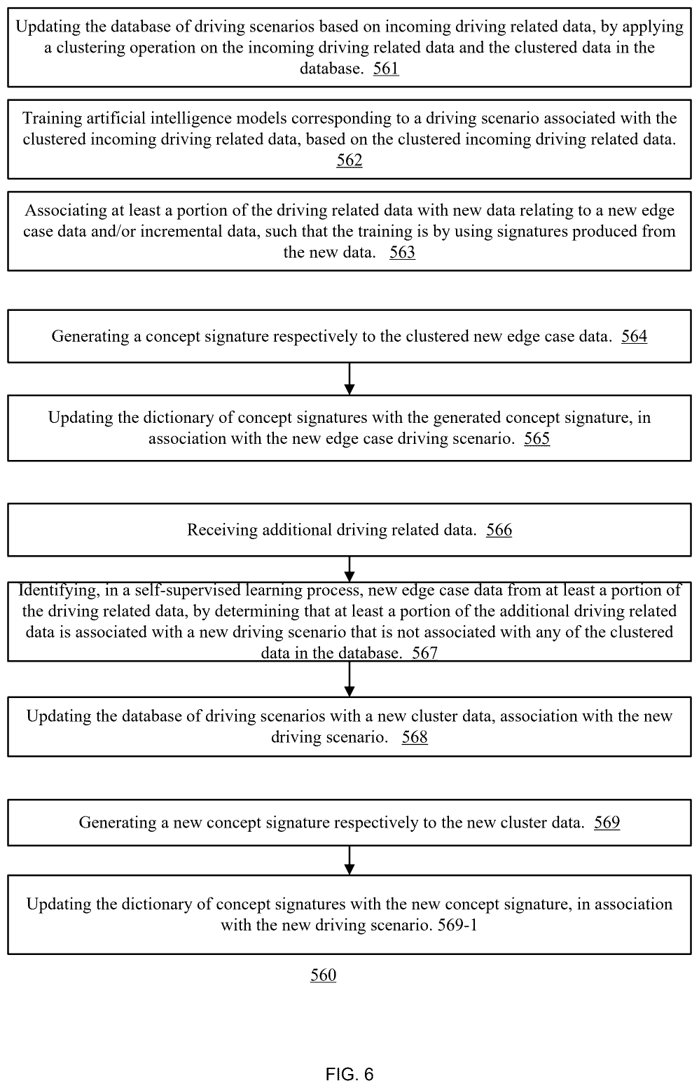

FIG. 6 illustrates step 560 as includes at least one of:
Step 561 of updating the database of driving scenarios based on incoming driving related data, by applying a clustering operation on the incoming driving related data and the clustered data in the database.
Step 562 of training artificial intelligence models corresponding to a driving scenario associated with the clustered incoming driving related data, based on the clustered incoming driving related data.
Step 563 of associating at least a portion of the driving related data with new data relating to a new edge case data and/or incremental data, such that the training is by using signatures produced from the new data.
Step 564 of generating a concept signature respectively to the clustered new edge case data, and step 565 of updating the dictionary of concept signatures with the generated concept signature, in association with the new edge case driving scenario.
Step 566 of receiving additional driving related data, step 567 of identifying, in a self-supervised learning process, new edge case data from at least a portion of the driving related data, by determining that at least a portion of the additional driving related data is associated with a new driving scenario that is not associated with any of the clustered data in the database; and step 568 of updating the database of driving scenarios with a new cluster data, association with the new driving scenario.
Step 569 of generating a new concept signature respectively to the new cluster data; and step 569-1 of updating the dictionary of concept signatures with the new concept signature, in association with the new driving scenario.

FIG. 7 illustrates method 700 of activation of artificial intelligence models for driving related scenarios.

According to an embodiment, method 700 includes step 710 of obtaining sensor data input relating to an environment of a vehicle.

According to an embodiment, step 710 is followed by step 720 of generating, in a driving of the vehicle, a signature based on the sensor data input.

According to an embodiment, step 720 is followed by step 730 of matching, in the driving of the vehicle, the signature with a set of concept signatures that are held in a dictionary of concept signatures in association with driving scenarios.

According to an embodiment, wherein there is no match (identifying that the signature does not match any of the set of concept signatures), step 730 is followed by step 760 of responding to the identifying that there is no match.

According to an embodiment, step 760 includes at least one of the following steps (illustrated in FIG. 8) of:
Step 761 of associating the sensor data input with new edge case data.
Step 762 of triggering a recording of the sensor data input.
Step 763 of triggering a transmission of the sensor data input to a computerized system associated with the vehicle and located externally to the vehicle.
Step 764 of using another sensor data input captured in a time proximity to a capturing of the sensor data input to verify that signature does not match any of the set of concept signatures held in the library. Time proximity-may be at the same time, within a time difference of up to 0.1, 0.5, 1, 2, 3, 4, 5, 6, 10, 15, 20, 30, 40, 50, seconds and the like.
Step 765 of using another sensor data input captured in a time proximity to a capturing of the sensor data input to determine the driving scenario.
Step 766 of triggering a training of a new artificial intelligence model with respect to the driving scenario faced by the vehicle.
Step 767 of triggering an update of the dictionary of concept signatures using the generated signature.

According to an embodiment, wherein there is a match, step 730 is followed by step 740 of responding to the match.

According to an embodiment, step 740 includes (illustrated in FIG. 9) at least one of:
Step 741 of determining a driving scenario, based on the matching.
Step 742 of generating instructions, executable by a processing unit of the vehicle, to issue a notification for activation of a selected set of artificial intelligence models, in accordance with the driving scenario, wherein the activation of the selected set of artificial intelligence models providing a decision making for the driving scenario with an autonomous driving application associated with the vehicle.
Step 743 of activating the selected set of artificial intelligence models, in accordance with the driving scenario.
Step 744 of generating a driving related output with respect to the vehicle. The driving related output is used for autonomously driving the vehicle.

According to an embodiment, the driving related output is used by an advanced driver assistance system (ADAS) related to the vehicle.

According to an embodiment, the driving related output includes at least one of:
An instruction executable by a man machine interface controller, to provide a recommendation to a driver regarding a navigation of the vehicle.
A request aimed to the man machine interface controller, to provide a recommendation to a driver regarding a navigation of the vehicle.
An instruction executable by an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
A request aimed to an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
An instruction executable by a driver assistance control unit (such as but not limited to an ADAS control unit) of the vehicle to perform a driver assisting operation—such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
A request aimed to a driver assistance control unit (such as but not limited to an ADAS control unit) of the vehicle to perform a driver assisting operation—such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
An instruction executable by a computer vehicle related to a manner of operation of any component of the vehicle such as brakes, engine, and the like.
A request sent to a computer vehicle related to a manner of operation of any component of the vehicle such as brakes, engine, and the like.
Information about the environment of the vehicle.
A prediction of a future path of the vehicle.
A prediction of a behavior of one or more road element.
An emergency alert.
A collision alert.

According to an embodiment, the method includes outputting and/or transmitting an/or storing and/or instructing to respond to and/or triggering a response to and/or controlling a response to and/or performing a respond to any of the driving related output listed above and/or below.

According to an embodiment, the method includes generating and/or requesting and/or determining and/or instructing and/or triggering and/or controlling and/or transmitting and/or outputting and/or preforming at least one of a warning, an alert signal, a driving alert, an estimated future driving of the vehicle, an estimated future behavior (e.g. movement) of any road element, an autonomous driving operation, an driving assistance output, a prediction output with respect to the behavior (e.g. movement, etc) of the element in the environment—and/or in the environment with re to the vehicle, an operation and/or response in compliant with one or more levels of autonomous driving—such as L2, L2+, L2++, L3 or L4 autonomous driving.

The providing of the driving related output may include storing the driving related output at a location accessible to another unit controller, transmitting instructions of the driving related output to the other unit, sending an indication about the generation of the instructions of the driving related output to the other unit man machine interface controller.

According to an embodiment, the method may include outputting and/or transmitting an/or storing and/or instructing to respond to and/or triggering a response to and/or controlling a response to and/or performing a respond to any of the driving related output listed above and/or below.

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

We claim

1. A method of activation of artificial intelligence models for driving related scenarios, comprising:
obtaining sensor data input relating to an environment of a vehicle;
generating, in a driving of the vehicle, a signature based on the sensor data input;
matching, in the driving of the vehicle, the signature with a set of concept signatures that are held in a dictionary of concept signatures in association with driving scenarios;
determining a driving scenario, based on the matching; and
generating instructions, executable by a processing unit of the vehicle, to issue a notification for activation of a selected set of artificial intelligence models, in accordance with the driving scenario, wherein the activation of the selected set of artificial intelligence models providing a decision making for the driving scenario with an autonomous driving application associated with the vehicle.

2. The method according to claim 1, further comprising:
identifying that the signature does not match any of the set of concept signatures; and
responding to the identifying.

3. The method according to claim 2, wherein responding to the identifying comprises associating the sensor data input with new edge case data.

4. The method according to claim 2, wherein responding to the identifying comprises triggering a recording of the sensor data input.

5. The method according to claim 2, wherein responding to the identifying comprises triggering a transmission of the sensor data input to a computerized system associated with the vehicle and located externally to the vehicle.

6. The method according to claim 2, wherein the responding comprises using another sensor data input captured in a time proximity to a capturing of the sensor data input to verify that signature does not match any of the set of concept signatures held in the library.

7. The method according to claim 2, wherein the responding comprises using another sensor data input captured in a time proximity to a capturing of the sensor data input to determine the driving scenario.

8. The method according to claim 2, wherein the responding comprises triggering a training of a new artificial intelligence model with respect to the driving scenario faced by the vehicle.

9. The method according to claim 2, wherein the responding comprises triggering an update of the dictionary of concept signatures using the generated signature.

10. The method according to claim 1, further comprising activating the selected set of artificial intelligence models, in accordance with the driving scenario.

11. A system of activating artificial intelligence models for driving related scenarios, the system comprising:
at least one processing device configured to:
obtain sensor data input relating to an environment of a vehicle;
generate, in a driving of the vehicle, a signature based on the sensor data input;
match, in the driving of the vehicle, the signature with a set of concept signatures that are held in a dictionary of concept signatures in association with driving scenarios;
determine a driving scenario, based on the matching; and
generate instructions, executable by a processing unit of the vehicle, to issue a notification for activation of a selected set of artificial intelligence models, in accordance with the driving scenario, such that the activation of the selected set of artificial intelligence models provides a decision making for the driving scenario with an autonomous driving application associated with the vehicle

12. A non-transitory computer readable medium storing instructions that, when executable by at least one processing device, cause the device to:
obtain sensor data input relating to an environment of a vehicle;
generate, in a driving of the vehicle, a signature based on the sensor data input;
match, in the driving of the vehicle, the signature with a set of concept signatures that are held in a dictionary of concept signatures in association with driving scenarios;
determine a driving scenario, based on the matching; and
generate instructions, executable by a processing unit of the vehicle, to issue a notification for activation of a selected set of artificial intelligence models, in accordance with the driving scenario, such that the activation of the selected set of artificial intelligence models provides a decision making for the driving scenario with an autonomous driving application associated with the vehicle

13. The non-transitory computer readable medium according to claim 11, further storing instructions that, when executable by the at least one processing device, cause the device to:
identify that the signature does not match any of the set of concept signatures; and
respond in case a signature mismatch is identified.

14. The non-transitory computer readable medium according to claim 12, wherein the instructions causing the device to respond to an identified signature mismatch causes the device to associate the sensor data input with new edge case data.

15. The non-transitory computer readable medium according to claim 12, wherein the instructions causing the device to respond to an identified signature mismatch causes the device to trigger a recording of the sensor data input.

16. The non-transitory computer readable medium according to claim 12, wherein the instructions causing the device to respond to an identified signature mismatch causes the device to trigger a transmission of the sensor data input to a computerized system associated with the vehicle and located externally to the vehicle.

17. The non-transitory computer readable medium according to claim 12, wherein the instructions causing the device to respond to an identified signature mismatch causes the device to use another sensor data input captured in a time proximity to a capture of the sensor data input to verify that signature does not match any of the set of concept signatures held in the library.

18. The non-transitory computer readable medium according to claim 12, wherein the instructions causing the device to respond to an identified signature mismatch causes the device to use another sensor data input captured in a time proximity to a capture of the sensor data input to determine the driving scenario.

19. The non-transitory computer readable medium according to claim 12, wherein the instructions causing the device to respond to an identified signature mismatch causes the device to trigger a training of a new artificial intelligence model with respect to the driving scenario faced by the vehicle.

20. The non-transitory computer readable medium according to claim 12, wherein the instructions causing the device to respond to an identified signature mismatch causes the device to trigger an update of the dictionary of concept signatures using the generated signature.
